(19) United States
(12) Patent Application Publication
(10) Pub. No.: US 2014/0340443 A1
(43) Pub. Date: Nov. 20, 2014

(54) IMAGE FORMATION APPARATUS

(71) Applicants: Yasuo KATANO, Kanagawa (JP); Shinji TEZUKA, Kanagawa (JP); Yukimichi SOMEYA, Saitama (JP); Fuminari KANEKO, Kanagawa (JP); Kohji TAKEUCHI, Kanagawa (JP); Hidekazu YAGINUMA, Kanagawa (JP)

(72) Inventors: Yasuo KATANO, Kanagawa (JP); Shinji TEZUKA, Kanagawa (JP); Yukimichi SOMEYA, Saitama (JP); Fuminari KANEKO, Kanagawa (JP); Kohji TAKEUCHI, Kanagawa (JP); Hidekazu YAGINUMA, Kanagawa (JP)

(73) Assignee: RICOH COMPANY, LTD., Tokyo (JP)

(21) Appl. No.: 14/272,712

(22) Filed: May 8, 2014

(30) Foreign Application Priority Data
May 16, 2013 (JP) 2013-104358
Jan. 24, 2014 (JP) 2014-010983

(51) Int. Cl. B41J 2/17

(52) U.S. Cl. CPC B41J 2/17
USPC 347/21

(57) ABSTRACT

An image formation apparatus includes an application part configured to apply a first solvent onto a recording medium and a jetting part configured to jet an ink-jet ink to be attached to the first solvent applied on the recording medium, wherein the ink-jet ink includes a second solvent, a resin, and a coloring material, wherein the second solvent is soluble in the first solvent and the resin is insoluble in the first solvent and soluble in the second solvent.

### BACKGROUND OF THE INVENTION

1. Field of the Invention

An aspect of the present invention relates to an image formation apparatus.

2. Description of the Related Art

As an ink-jet ink attaches to a recording medium, bleeding is readily caused generally. As an ink-jet ink attaches to, for example, a plain paper sheet, the ink-jet ink readily spreads along a pulp fiber mesh to cause bleeding. As bleeding of an ink-jet ink is caused, image degradation is caused because an image density is reduced or an edge of an image is blurred.

Japanese Patent Application Publication No. 2011-143705 discloses an oily ink-jet printing method, wherein printing is conducted by applying a pretreatment fluid to a printing medium and subsequently jetting an oily ink that includes at least a pigment and a solvent onto the printing medium. Herein, the pretreatment fluid includes at least inorganic particles with an average particle diameter greater than or equal to 1 μm and less than or equal to 20 μm and a solvent and a difference between a solubility parameter (SP value) of the solvent in the pretreatment fluid and a solubility parameter (SP value) of the solvent in the oily ink is greater than or equal to 1.0 (cal/cm³)^{1/2}.

Because, however, the pretreatment fluid includes the inorganic particles, there is a problem that a cost is raised, or in a case where the printing medium is a transparent film, a transparency of the printing medium is reduced.

### SUMMARY OF THE INVENTION

According to one aspect of the present invention, there is provided an image formation apparatus, including an application part configured to apply a first solvent onto a recording medium and a jetting part configured to jet an ink-jet ink to be attached to the first solvent applied on the recording medium, wherein the ink-jet ink includes a second solvent, a resin, and a coloring material, wherein the second solvent is soluble in the first solvent and the resin is insoluble in the first solvent and soluble in the second solvent.

According to another aspect of the present invention, there is provided an image formation apparatus, including an intermediate transfer body, an application part configured to apply a first solvent on the intermediate transfer body, a jetting part configured to jet an ink-jet ink to be attached to the first solvent applied on the intermediate transfer body, and a transfer part configured to transfer the ink-jet ink attached to the first solvent to a recording medium, wherein the ink-jet ink includes a second solvent, a resin, and a coloring material, wherein the second solvent is soluble in the first solvent and the resin is insoluble in the first solvent and soluble in the second solvent.

### BRIEF DESCRIPTION OF THE DRAWINGS

FIG. 1A, FIG. 1B, and FIG. 1C are schematic diagrams that illustrate an image formation method according to a first embodiment of the present invention.

FIG. 2 is a conceptual diagram that illustrates one example of a method for selecting a first solvent, a second solvent, and a resin.

FIG. 3 is a conceptual diagram that illustrates another example of a method for selecting a first solvent, a second solvent, and a resin.

FIG. 4A, FIG. 4B, FIG. 4C, and FIG. 4D are schematic diagrams that illustrate an image formation method according to a second embodiment of the present invention.

FIG. 5 is a schematic diagram that illustrates an image formation apparatus according to a first embodiment of the present invention.

FIG. 6 is a schematic diagram that illustrates an image formation apparatus according to a second embodiment of the present invention.

FIG. 7 is a schematic diagram that illustrates an image formation apparatus according to a third embodiment of the present invention.

FIG. 8 is a schematic diagram that illustrates an image formation apparatus according to a fourth embodiment of the present invention.

FIG. 9 is a schematic diagram that illustrates an image formation apparatus according to a fifth embodiment of the present invention.

FIG. 10 is a schematic diagram that illustrates an image formation apparatus according to a sixth embodiment of the present invention.

FIG. 11 is a schematic diagram that illustrates an image formation apparatus according to a seventh embodiment of the present invention.

FIG. 12 is a schematic diagram that illustrates an image formation apparatus according to a eighth embodiment of the present invention.

FIG. 13A and FIG. 13B are optical microscopic photographs of an image in Practical Example 1.

FIG. 14A and FIG. 14B are optical microscopic photographs of an image in Comparative Example 1.

FIG. 15 is an optical microscopic photograph of an image in Practical Example 2.

FIG. 16 is an optical microscopic photograph of an image in Comparative Example 2.

### DETAILED DESCRIPTION OF THE PREFERRED EMBODIMENTS

Next, some embodiments for implementing the present invention will be described in conjunction with the drawings.

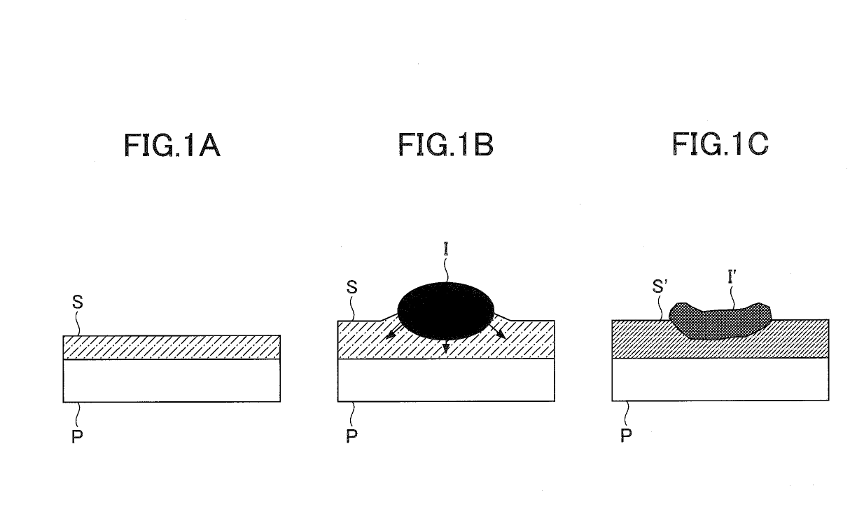

FIG. 1A, FIG. 1B, and FIG. 1C illustrate an image formation method according to a first embodiment of the present invention.

First, a first solvent S is applied to an entire surface of a paper sheet P (see FIG. 1A).

Then, an ink-jet ink I is jetted to be attached to the first solvent S applied on the paper sheet P (see FIG. 1B). Herein, the ink-jet ink I includes a second solvent, a resin, and a coloring material, wherein the second solvent is soluble in the first solvent S and the resin is insoluble in the first solvent S and soluble in the second solvent. Accordingly, the first solvent S is capable of precipitating the resin as the ink-jet ink I is dropped thereon.

As the ink-jet ink I is attached to the first solvent S, the second solvent in the ink-jet ink immediately diffuses into the first solvent S to be an admixed solvent S′ in which the first solvent and the second solvent are admixed and to produce an ink-jet ink I′ with an increased viscosity (see FIG. 1C). Herein, the resin and the coloring material hardly diffuse into the first solvent S, because the resin in the ink-jet ink I is not dissolved in the first solvent S. As a result, the resin and the coloring material in the ink-jet ink I′ with an increased viscosity hardly diffuse so that it is possible to suppress occurrence of bleeding. Because the admixed solvent S′ is subsequently vaporized or spreads into an inside of the paper sheet P, the ink-jet ink I′ with an increased viscosity is solidified and fixed on the paper sheet P. As a result, it is possible to form a sharp image with a high image density. Furthermore, it is possible to simplify a configuration of an image formation apparatus.

A viscosity of the first solvent S at 25° C. is usually less than or equal to 30 mPa·S. Thereby, it is possible to apply the first solvent S in such a manner that a speed of conveyance of the paper sheet P is a high speed greater than or equal to 500 mm/s and a thickness of a fluid film is uniform or has an irregularity less than or equal to ±30% of an average thickness thereof.

Viscosities of the ink-jet ink I and the second solvent at 25° C. are usually less than or equal to 30 mPa·s. Thereby, it is possible to jet the ink-jet ink I by using an ink-jet head.

Accordingly, a diffusion rate of diffusion of the second solvent into the first solvent S is sufficiently greater than a diffusion rate of diffusion of the resin and the coloring material into the first solvent S. As a result, in a state illustrated in FIG. 1B, the second solvent diffuses into the first solvent S before the resin and the coloring material diffuse into the first solvent S, and an area with an increased viscosity is formed near a contact face between the ink-jet ink I and the first solvent S so that it is possible to suppress diffusion of the resin and the coloring material into the first solvent S.

A diffusion coefficient of diffusion between liquids is usually about 1×10⁻⁹ m²/s. By conducting a calculation based on a diffusion equation, it is possible to understand that if a diffusion coefficient of diffusion of the second solvent into the first solvent S is also comparable thereto, it takes ten and several milliseconds to a hundred and several tens of milliseconds from attachment of the ink-jet ink I to the first solvent S to a time at when a concentration of the second solvent in the ink-jet ink I′ with an increased viscosity is approximately a half of a concentration of the second solvent in the ink-jet ink I. Thereby, it is possible to increase a viscosity of the ink-jet ink I at a high speed and it is possible to form an image while a speed of conveyance of the paper sheet P is a high speed greater than or equal to 500 mm/s.

When a diffusion rate of diffusion of the second solvent into the first solvent S is greater, it is possible to suppress diffusion of the resin and the coloring material into the first solvent S as the ink-jet ink I is attached to the first solvent S. That is, it is preferable for a diffusion coefficient of diffusion of the second solvent into the first solvent S to be 1×10⁻⁹ to 1×10⁻¹¹ m²/s on a condition that an image is formed in an image formation apparatus practically. Herein, a diffusion coefficient depends on a temperature and a viscosity, wherein the viscosity depends on the temperature.

It is preferable for an area of the paper sheet P in which the first solvent S is applied thereon to be generally identical to an area in which the ink-jet ink I is attached thereto. Thereby, it is possible to reduce an amount of the first solvent S to be used. An essential condition in the present embodiment is that the second solvent is soluble in the first solvent S and the resin is insoluble in the first solvent S and soluble in the second solvent.

Here, a second solvent being soluble in a first solvent in the present specification and what is claimed refers to a transparent and non-separated condition in a case where a first solvent and a second solvent at a mass ratio of 1:1 are stirred in a glass bottle in an environment of 25° C. and 1 bar and subsequently left at rest for 30 minutes.

Furthermore, a resin being insoluble in a first solvent in the present specification and what is claimed refers to a condition that a solid is found in a glass bottle in a case where a first solvent and a resin at a mass ratio of 99:1 are stirred in the glass bottle in an environment of 25° C. and 1 bar and subsequently left at rest for 1 hour.

Moreover, a resin being soluble in a second solvent in the present specification and what is claimed refers to a condition that a precipitation is not generated on a bottom portion of a glass bottle in a case where a second solvent and a resin at a mass ratio of 99:1 are heated and stirred in the glass bottle in an environment of 25° C. and 1 bar to be transparent and subsequently left at rest for 1 week.

Meanwhile, there is a solubility parameter (an SP value) as a characteristic value that provides an indication for being soluble and being insoluble. A general tendency is that when a difference between SP values is small, dissolution is readily attained, and when a difference between SP values is large, dissolution is hardly attained.

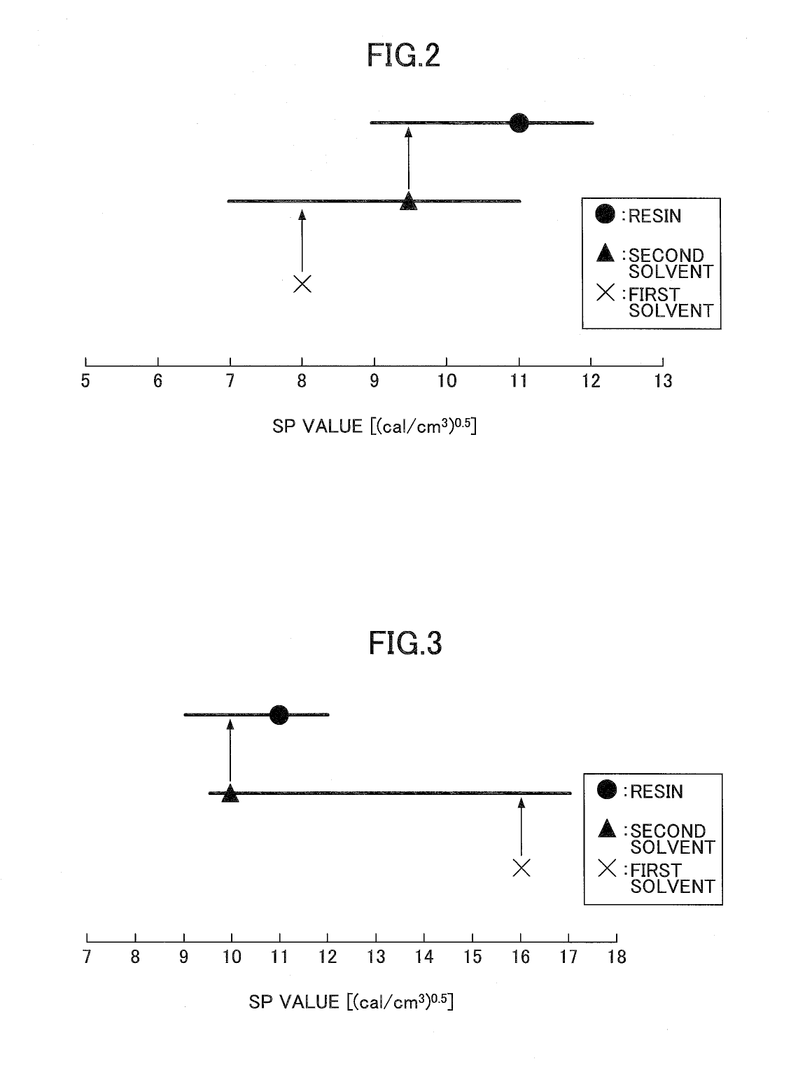

FIG. 2 and FIG. 3 illustrate a method for selecting the first solvent, the second solvent, and the resin.

In FIG. 2, an SP value of a resin is 11.0 (cal/cm³)^{0.5} and a range of an SP value of a solvent in which a resin is soluble is 9.0-12.0 (cal/cm³)^{0.5}. Herein, if a solvent with an SP value that is 9.5 (cal/cm³)^{0.5} is selected as a second solvent, the resin is soluble in the second solvent. Furthermore, a range of an SP value of a solvent in which a second solvent is soluble is 7.0-11.0 (cal/cm³)^{0.5}. Herein, if a solvent with an SP value that is 8.0 (cal/cm³)^{0.5} is selected as a first solvent, the second solvent is soluble in the first solvent and the resin is insoluble in the first solvent.

In FIG. 3, an SP value of a resin is 11.0 (cal/cm³)^{0.5} and a range of an SP value of a solvent in which a resin is soluble is 9.0-12.0 (cal/cm³)^{0.5}. Herein, if a solvent with an SP value that is 10.0 (cal/cm³)^{0.5} is selected as a second solvent, the resin is soluble in the second solvent. Furthermore, a range of an SP value of a solvent in which a second solvent is soluble is 9.0-17.0 (cal/cm³)^{0.5}. Herein, if a solvent with an SP value that is 16.0 (cal/cm³)^{0.5} is selected as a first solvent, the second solvent is soluble in the first solvent and the resin is insoluble in the first solvent.

Here, it is preferable for an SP value of the second solvent to be slightly higher than a lower limit of a range of an SP value at which the resin is soluble or slightly lower than an upper limit of a range of an SP value at which the resin is soluble. Thereby, it is possible to increase a viscosity of the ink-jet ink I attached to the first solvent S in a short time. It is considered that this is because the second solvent diffuses into the first solvent S so that the resin is precipitated rapidly.

Furthermore, it is preferable for an SP value of the first solvent S to have a large difference from a lower limit or an upper limit of a range of an SP value at which the resin is soluble. Thereby, it is possible to increase a viscosity of the ink-jet ink I attached to the first solvent S in a short time. It is considered that this is because the first solvent S slightly diffuses into the ink-jet ink I so that the resin is readily precipitated.

Here, although it is not possible for only an SP value to explain all of being soluble and being insoluble, it is desirable to select materials based on the aforementioned concept, with respect to a combination of materials to which a concept of SP values applies.

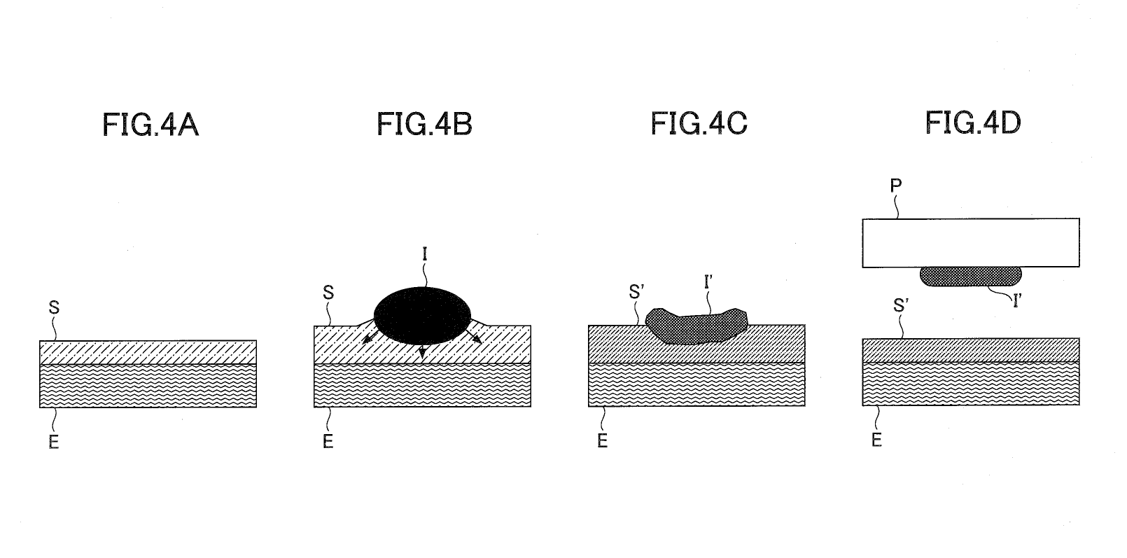

FIG. 4A, FIG. 4B, FIG. 4C, and FIG. 4D illustrate an image formation method according to a second embodiment of the present invention.

First, a first solvent S is applied to an entire surface of a sheet-shaped elastic member E as an intermediate transfer body (see FIG. 4A).

Then, an ink-jet ink I is jetted to be attached to the first solvent S applied on the elastic member E (see FIG. 4B). Herein, the ink-jet ink I includes a second solvent, a resin, and a coloring material, wherein the second solvent is soluble in the first solvent S and the resin is insoluble in the first solvent S and soluble in the second solvent. Accordingly, as the ink-jet ink I is dropped onto the first solvent S, it is possible to precipitate the resin.

As the ink-jet ink I is attached to the first solvent S, the second solvent in the ink-jet ink I immediately diffuses into the first solvent S to be an admixed solvent S′ in which the first solvent and the second solvent are admixed and to produce an ink-let ink I′ with an increased viscosity (see FIG. 4C). Herein, the resin and the coloring material hardly diffuse into the first solvent S, because the resin in the ink-jet ink I is not dissolved in the first solvent S. As a result, the resin and the coloring material in the ink-jet ink I′ with an increased viscosity hardly diffuse so that it is possible to suppress occurrence of bleeding.

Moreover, the ink-jet ink I′ with an increased viscosity is transferred to a paper sheet P (see FIG. 4D). Because the admixed solvent S′ between the ink-jet ink I′ with an increased viscosity and the elastic member E is a shielding layer, it is possible to improve a transfer property. Herein, it is possible to further suppress occurrence of bleeding, because the resin and the coloring material in the ink-jet ink I′ with an increased viscosity transferred on the paper sheet P hardly diffuse. Subsequently, because the admixed solvent S′ remaining in the ink-jet ink I′ with an increased viscosity transferred on the paper sheet P is vaporized or diffuses into an inside of the paper sheet P, the ink-jet ink I′ with an increased viscosity is solidified and fixed on the paper sheet P. As a result, it is possible to form a sharper image with a higher image density. Furthermore, it is possible to simplify a structure of an image formation apparatus.

As described previously, it takes ten and several milliseconds to a hundred and several tens of milliseconds from attachment of the ink-jet ink I to the first solvent to a time at when a concentration of the second solvent in the ink-jet ink I′ with an increased viscosity is approximately a half of a viscosity of the second solvent in the ink-jet ink I.

A period of time from attachment of the ink-jet ink I to the first solvent S applied on the elastic member E to transfer of the ink-jet ink I′ with an increased viscosity to the paper sheet P is usually greater than or equal to ten and several milliseconds to a hundred and several tens of milliseconds. If a period of time from attachment of the ink-jet ink I to the first solvent S applied on the elastic member E to transfer of the ink-jet ink I′ with an increased viscosity to the paper sheet P is less than ten and several milliseconds to a hundred and several tens of milliseconds, bleeding may occur.

Here, a surface of the elastic member E may be roughened.

Furthermore, a roller-shaped elastic member, a belt-shaped elastic member or the like that is supported by a plurality of rollers, or the like may be used instead of the elastic member E.

It is preferable for an area of the elastic member E to which the first solvent S is applied to be generally identical to an area to which the ink-jet ink I is attached. Thereby, it is possible to reduce an amount of the first solvent S to be used. Furthermore, it is possible to suppress transfer of the first solvent S to the paper sheet P.

A viscosity of the ink-jet ink I is usually about 1-20 mPa·s.

A resin for an oily ink is not particularly limited and it is possible to provide a polystyrene, a polyester, an epoxy resin, an acryl resin, and a copolymer that includes at least one of them in a backbone thereof, a rosin-modified phenol resin, an alkyd resin, or the like.

A second solvent for an oily ink is not particularly limited as long as a resin for an oily ink is soluble therein, and it is possible to provide a dibasic acid ester such as a dimethyl succinate, a diethyl succinate, a dibutyl adipate, a diisobutyl adipate, or a dibutyl sebacate, a fatty acid ester such as an ethyl laurate, an isopropyl myristate, or a butyl palmitate, or the like.

A first solvent S for an oily ink is not particularly limited as long as a resin for an oily ink is insoluble therein and the second solvent for an oily ink is soluble therein, and it is possible to provide a high boiling point paraffin-type hydrocarbon that is a liquid at a room temperature, such as a tridecane, a tetradecane, a pentadecane, a hexadecane, a heptadecane or 2,2,4,4,6,8,8-heptamethylnonane, a high boiling point olefin-type hydrocarbon such as a pentadecene, a hexadecene, or a heptadecene, a dimethyl silicone oil, a fatty-acid-ester-modified silicone oil, a 2-ethylhexyl isononanoate, an isopropyl myristate, water, or the like, wherein two or more kinds thereof may be used in combination.

A resin for an aqueous ink is not particularly limited and it is possible to provide a polyvinyl alcohol, a polyvinyl pyrrolidone, or the like.

A second solvent for an aqueous ink is not particularly limited as long as a resin for an aqueous ink is soluble therein, and it is possible to provide a glycol such as a glycerin or a butylene glycol, water, or the like.

A first solvent S for an aqueous ink is not particularly limited as long as a resin for an aqueous ink is insoluble therein and a second solvent for an aqueous ink is soluble therein, and it is possible to provide an alcohol such as an ethanol or an isopropyl alcohol, or the like.

A coloring material may be any of a dye and a pigment, wherein a pigment is preferable because diffusion thereof into a first solvent S is hardly caused.

A pigment is not particularly limited, and it is possible to provide a carbon black, a phthalocyanine blue, a monoazo yellow, disazo yellow, benzimidazole-type yellow, an anthraquinone-type yellow, a polyazo-type yellow, a monoazo red, brilliant carmine 6B, an anthraquinone red, a dimethylquinacridone, or the like.

In a case where a pigment is used as a coloring material, it is preferable to use a pigment dispersing agent in order to be uniformly dispersed in a second solvent.

A pigment dispersing agent is not particularly limited, and it is possible to provide an alkyl-ammonium-type polymer dispersing agent, a block-copolymer-type polymer dispersing agent, a phosphoric acid ester salt dispersing agent, or the like.

A paper sheet P is not particularly limited, and it is possible to provide a special paper sheet such as an art paper sheet, a super art paper sheet, a daruato paper sheet, a super daruato paper sheet, or a coated paper sheet, or a plain paper sheet such as a middle quality paper sheet, a high quality paper sheet, or a paper sheet for PPC.

Here, a transparent film such as a PET film or a polypropylene film or a metal sheet such as an aluminum sheet or a stainless steel sheet may be used instead of a paper sheet P.

FIG. 5 illustrates an image formation apparatus according to a first embodiment of the present invention. Here, an identical reference numeral will be attached to a configuration in FIG. 5 that is identical to that in FIG. 1A, FIG. 1B, and FIG. 1C and a description thereof will be omitted.

An image formation apparatus 10 has an application roller 11 for applying a (non-illustrated) first solvent to an entire surface of a paper sheet P, a sponge 12 for supplying the first solvent to the application roller 11, an ink-jet head 13 for jetting an ink-jet ink I in accordance with an image signal to be attached to the first solvent applied on the paper sheet P, and a conveyance roller 14 and conveyance belt 15 for conveying the paper sheet P.

The sponge 12 contacts the application roller 11 and is impregnated with the first solvent.

A width of the sponge 12 is generally identical to a paper sheet width.

The ink-jet head 13 may be any of a shuttle-type head for mechanical scanning in a sub-scanning direction and a line-type head with all of nozzles arrayed in a paper sheet width.

The ink-jet head 13 is connected to an (non-illustrated) ink container for containing the ink-jet ink I via a (non-illustrated) tube and a (non-illustrated) pump.

An amount of the first solvent to be applied on an entire surface of the paper sheet P is usually 0.02-0.3 mg/cm², and preferably 0.03-0.2 mg/cm². If an amount of the first solvent to be applied on an entire surface of the paper sheet P is less than 0.02 mg/cm², a viscosity of the ink-jet ink I attached to the first solvent may hardly be increased, and if it is greater than 0.3 mg/cm², feeling of a fluid residue may be caused on the paper sheet P.

A period of time from application of the first solvent to the paper sheet P to attachment of the ink-jet ink I to the first solvent is usually less than or equal to 100 ms. If a period of time from application of the first solvent S to the paper sheet P to attachment of the ink-jet ink I to the first solvent S is greater than 100 ms, the first solvent S may penetrate into an inside of the paper sheet P to hardly increase a viscosity of the ink-jet ink I attached to the first solvent S.

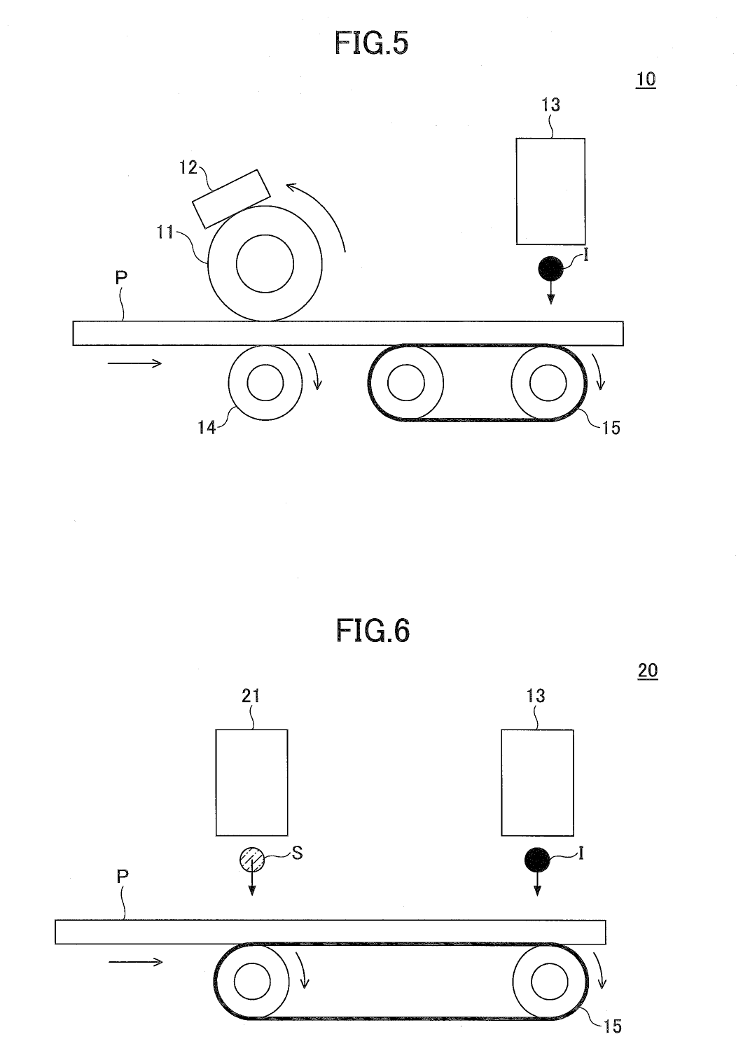

FIG. 6 illustrates an image formation apparatus according to a second embodiment of the present invention.

An image formation apparatus 20 has a configuration identical to that of the image formation apparatus 10 except that an ink-jet head 21 for jetting a first solvent S in accordance with an image signal to be applied to a paper sheet P is used instead of the application roller 11 and the sponge 12 and the conveyance roller 14 is omitted.

Here, in a case where a monochromatic image is formed, an image signal identical to a signal to be sent to the ink-jet head 13 is sent to the ink-jet head 21.

Furthermore, in a case where a color image is formed, an image signal provided by changing a color image into a monochromatic binary image is sent to the ink-jet head 21.

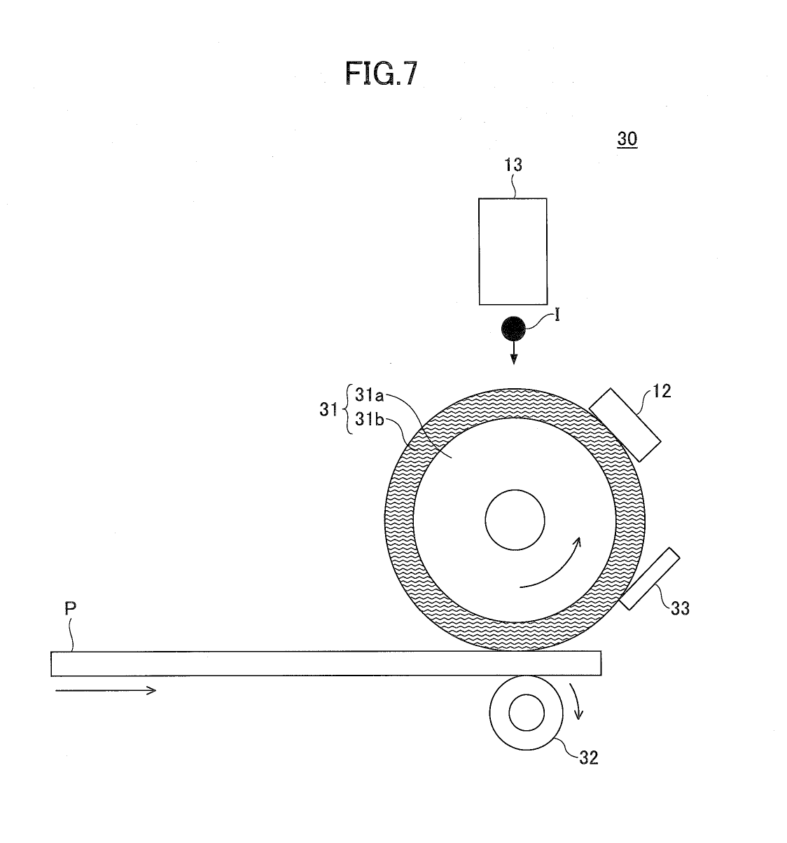

FIG. 7 illustrates an image formation apparatus according to a third embodiment of the present invention. Here, an identical reference numeral will be attached to a configuration in FIG. 7 that is identical to that in FIG. 5 and a description thereof will be omitted.

An image formation apparatus 30 has an intermediate transfer roller 13 in which an elastic layer 31b is formed on a supporter 31a, a sponge 12 for supplying a (non-illustrated) first solvent to an entire surface of the intermediate transfer roller 31, an ink-jet head 13 for jetting an ink-jet ink I in accordance with an image signal to be attached to the first solvent applied on the intermediate transfer roller 31, a pressurization roller 32 for transferring the ink-jet ink with a viscosity increased by attaching to the first solvent to a paper sheet P, and a cleaning pad 33 for eliminating an ink-jet ink remaining on the intermediate transfer roller 31 on which the ink-jet ink with an increased viscosity is transferred, a admixed solvent, paper powder, or the like.

A material that composes the supporter 31a is not particularly limited, and it is possible to provide a thermoplastic resin such as a polyethylene terephthalate, a heat-resistant resin such as a polyimide, a polyamide-imide, or a polyether ketone, a metal material such as a stainless steel, a nickel, an aluminum, or an iron, or the like,

A material that composes the elastic layer 31b is not particularly limited as long as a wettability with respect to the first solvent is good, and it is possible to provide a silicone rubber, an NBR rubber, a chloroprene rubber, a urethane rubber, a fluororubber, or the like.

Here, the intermediate transfer roller 31 may be such that a releasing layer is further formed on the elastic layer 31b.

A material that composes the releasing layer is not particularly limited, and it is possible to provide a fluororesin such as a tetrafluoroethylene-perfluoroalkyl vinyl ether copolymer (PFA), a polyvinylidene fluoride (PVDF), a polytetrafluoroethylene (PTFE), an ethylene-tetrafluoroethylene copolymer (ETFE), a polychlorotrifluoroethylene (PCTFE), a tetrafluoroethylene-hexafluoropropylene copolymer (FEP), or a tetrafluoroethylene-hexafluoropropylene-vinylidene fluoride copolymer (THV), or the like.

Furthermore, the intermediate transfer roller 31 may be such that an elastic layer is not formed.

The pressurization roller 32 is such that a (non-illustrated) elastic layer is formed on a (non-illustrated) supporter.

A width of the cleaning pad 33 is generally identical to a paper sheet width.

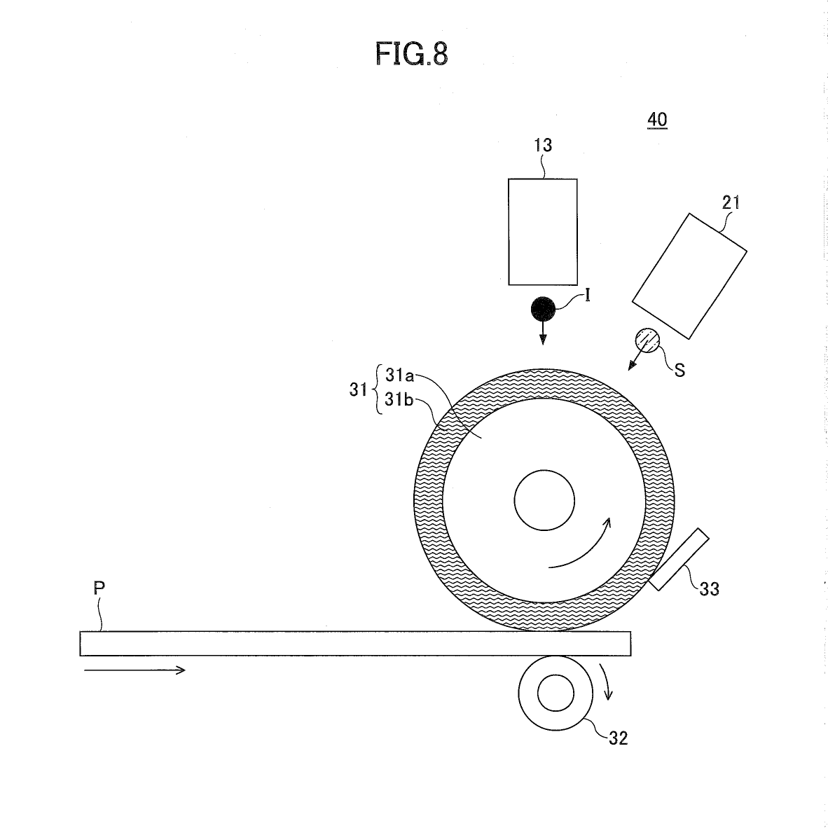

FIG. 8 illustrates an image formation apparatus according to a fourth embodiment of the present invention. Here, an identical reference numeral will be attached to a configuration in FIG. 8 that is identical to that in FIG. 6 and a description thereof will be omitted.

An image formation apparatus 40 has a configuration identical to that of the image formation apparatus 30 except that an ink-jet head 21 for jetting a first solvent S in accordance with an image signal to be applied to an intermediate transfer roller 31 is used instead of the sponge 12.

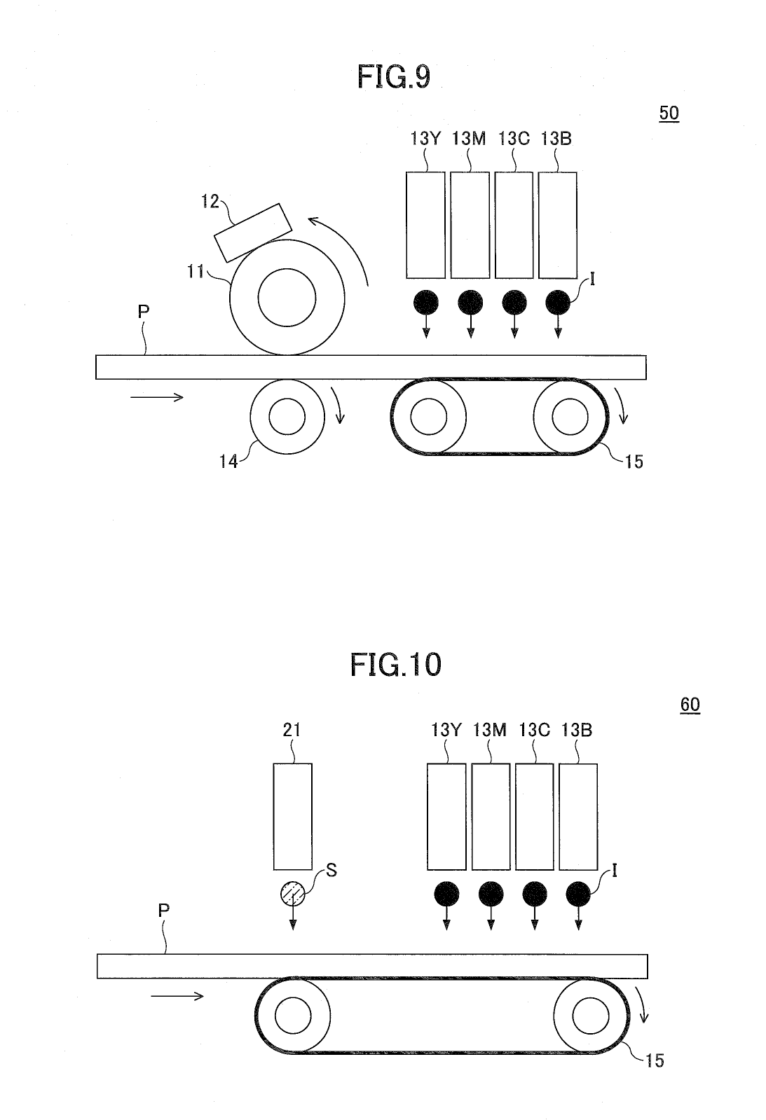

FIG. 9 illustrates an image formation apparatus according to a fifth embodiment of the present invention.

An image formation apparatus 50 has a configuration identical to that of the image formation apparatus 10 except that ink-jet heads 13Y, 13M, 13C, and 13B for a yellow ink, a magenta ink, a cyan ink, and a black ink are placed sequentially instead of the ink-jet head 13.

FIG. 10 illustrates an image formation apparatus according to a sixth embodiment of the present invention.

An image formation apparatus 60 has a configuration identical to that of the image formation apparatus 20 except that ink-jet heads 13Y, 13M, 13C, and 13B for a yellow ink, a magenta ink, a cyan ink, and a black ink are placed sequentially instead of the ink-jet head 13.

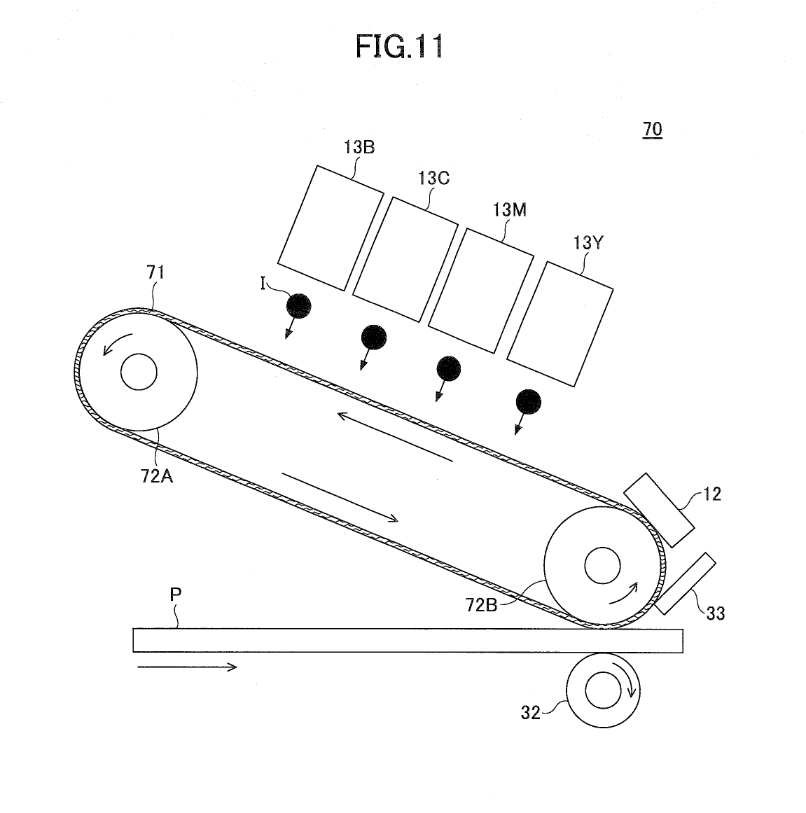

FIG. 11 illustrates an image formation apparatus according to a seventh embodiment of the present invention.

An image formation apparatus 70 has a configuration identical to that of the image formation apparatus 30 except that ink-jet heads 13Y, 13M, 13C, and 13B for a yellow ink, a magenta ink, a cyan ink, and a black ink are placed sequentially instead of the ink-jet head 13 and an intermediate transfer belt 71 is used instead of the intermediate transfer roller 31.

The intermediate transfer belt 71 is such that a (non-illustrated) elastic layer is formed on a (non-illustrated) supporter.

A material that composes the supporter of the intermediate transfer belt 71 is not particularly limited, and it is possible to provide a thermoplastic resin such as a polyethylene terephthalate, a heat-resistant resin such as a polyimide, a polyamide-imide, or a polyether ketone, a metal material such as a stainless steel, a nickel, an aluminum, or an iron, or the like.

A material that composes the elastic layer of the intermediate transfer belt 71 is not particularly limited as long as a wettability with respect to the first solvent is good, and it is possible to provide a silicone rubber, an NBR rubber, a chloroprene rubber, a urethane rubber, or a fluororubber, or the like.

The intermediate transfer belt 71 may be such that a releasing layer is further formed on the elastic layer.

A material that composes the releasing layer is not particularly limited, and it is possible to provide a fluororesin such as a tetrafluoroethylene-perfluoroalkyl vinyl ether copolymer (PFA), a polyvinylidene fluoride (PVDF), a polytetrafluoroethylene (PTFE), an ethylene-tetrafluoroethylene copolymer (ETFE), a polychlorotrifluoroethylene (PCTFE), a tetrafluoroethylene-hexafluoropropylene copolymer (FEP), or a tetrafluoroethylene-hexafluoropropylene-vinylidene fluoride copolymer (THV), or the like.

Furthermore, the intermediate transfer belt 71 may be such that an elastic layer is not formed.

The intermediate transfer belt 71 is supported by a constant tension of tension rollers 72A and 72B.

A material(s) that compose(s) the tension rollers 72A and 72B is/are not particularly limited, and it is possible to provide a metal such as an aluminum, an iron, or a stainless steel, an alloy thereof, a ceramic, or the like.

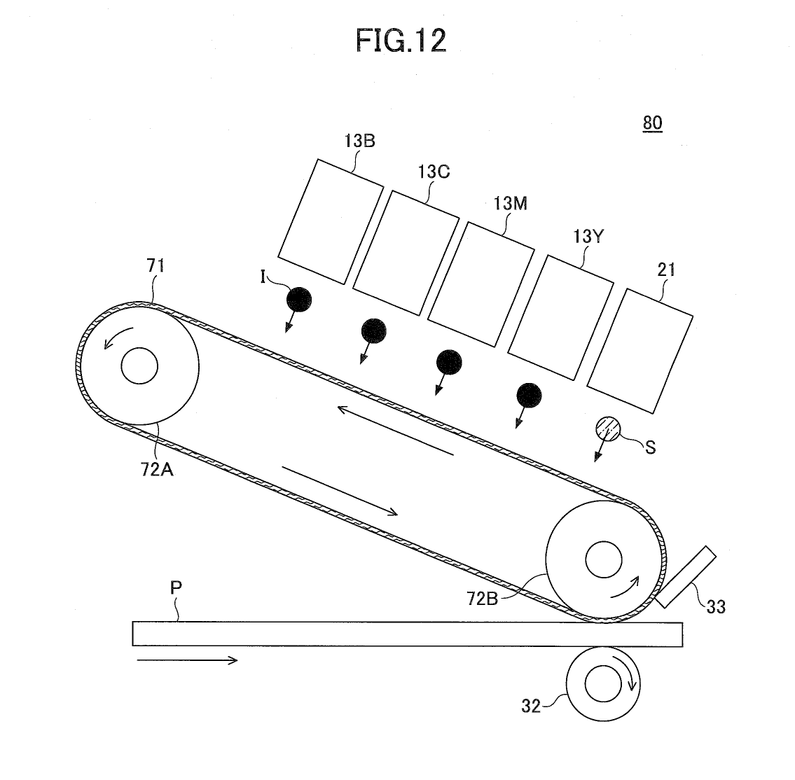

FIG. 12 illustrates an image formation apparatus according to an eighth embodiment of the present invention.

An image formation apparatus 80 has a configuration identical to that of the image formation apparatus 40 except that ink-jet heads 13Y, 13M, 13C, and 13B for a yellow ink, a magenta ink, a cyan ink, and a black ink are placed sequentially instead of the ink-jet head 13 and an intermediate transfer belt 71 is used instead of the intermediate transfer roller 31.

In the present practical examples, a “part” means a part by mass.

### PRACTICAL EXAMPLE 1

After 12 parts of a low-molecular weight polystyrene ST-95 with an SP value of 9.2 (cal/cm³)^{0.5} (produced by SANYOKASEI CO., LTD.) were dissolved in 82 parts of isopropyl myristate with an SP value of 8.6 (cal/cm³)^{0.5} while stirring thereof was conducted by using a stirrer, 4 parts of a pigment dispersing agent DISPERBYK-2155 (produced by BYK Japan K.K.) were dissolved therein. After an obtained solution, 2 parts of carbon black #2350 (produced by Mitsubishi Chemical Corporation), and zirconia beads with a diameter of 1 mm were then put into a container, dispersion thereof was conducted for 12 hours by using a ball mill. Moreover, filtration thereof was conducted by using a filter having a pore size of 0.45 μm and made of PTFE to obtain an ink-jet ink.

1 dot line at 600 dpi was printed by using the image formation apparatus 10. Herein, a pulse injector PIJ-15NSET with a single nozzle head (produced by CLUSTER TECHNOLOGY CO., LTD.) was used as the ink-jet head 13. Furthermore, a fatty-acid-ester-modified silicone oil TSF410 with an SP value of 8.1 (cal/cm³)^{0.5} (produced by MOMENTIVE PERFORMANCE MATERIALS INC.) was used as the first solvent. Moreover, a urethane foam member was used as the sponge 12. Furthermore, a roller made of a urethane rubber was used as the application roller 11. Moreover, an A4 paper sheet for PPC Mypaper (produced by RICOH COMPANY, LTD.) was used as the paper sheet P and an A4 PET film was used instead of the paper sheet P. Furthermore, the application roller 11 and the ink-jet head 13 were arranged in such a manner that a period of time from application of the first solvent to the paper sheet P to attachment of the ink-jet ink I to the first solvent was 0.5 seconds. Moreover, after the first solvent was applied in such a manner that its amount applied on an entire surface of the paper sheet P was 0.13 mg/cm², about 8 pL of the ink-jet ink I was attached to the first solvent S.

Here, it was confirmed that isopropyl myristate was soluble in the fatty-acid-ester-modified silicone oil TSF410 (produced by MOMENTIVE PERFORMANCE

MATERIALS INC.) and the low-molecular weight polystyrene ST-95 (produced by SANYOKASEI CO., LTD.) was insoluble in the fatty-acid-ester-modified silicone oil TSF410 (produced by MOMENTIVE PERFORMANCE MATERIALS INC.) and soluble in isopropyl myristate.

Furthermore, after 1 drop of the ink-jet ink was dropped by a dropping pipette onto a slide glass on which the fatty-acid-ester-modified silicone oil TSF410 (produced by MOMENTIVE PERFORMANCE MATERIALS INC.) was applied, in an environment at 25° C. and 1 bar, it was observed by an optical microscope that a resin was precipitated on a condition that a pigment was included therein.

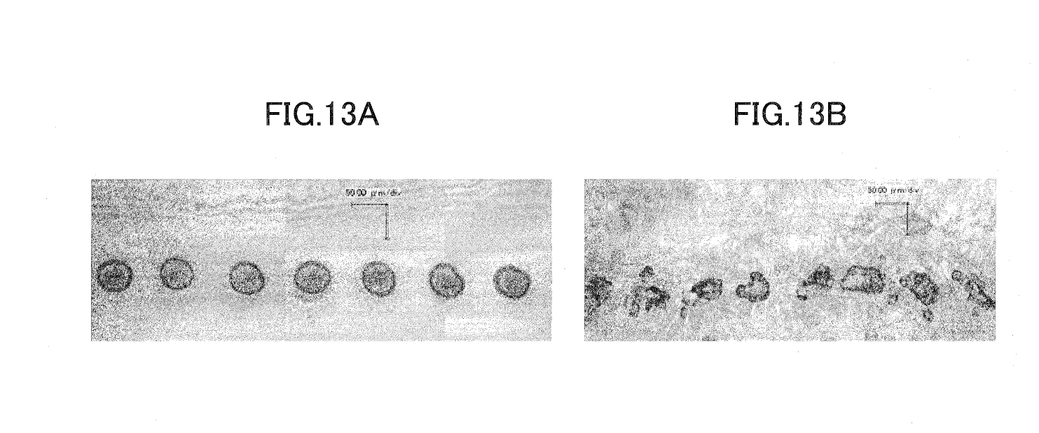

FIG. 13A and FIG. 13B illustrates optical microscopic photographs of an image. Here, FIG. 13A and FIG. 13B are provided for the PET film and the paper sheet for PPC, respectively.

It is found from FIG. 13A that a generally circular dot was formed on the PET film and bleeding was not caused. Furthermore, it is found from FIG. 13B that a dot with an irregular shape due to an influence of an irregularity of a pulp fiber mesh and a smoothly curved edge was formed on the paper sheet for PPC and bleeding was not caused.

### COMPARATIVE EXAMPLE 1

1 dot line at 600 dpi was printed similarly to Practical Example 1 except that the first solvent was not applied.

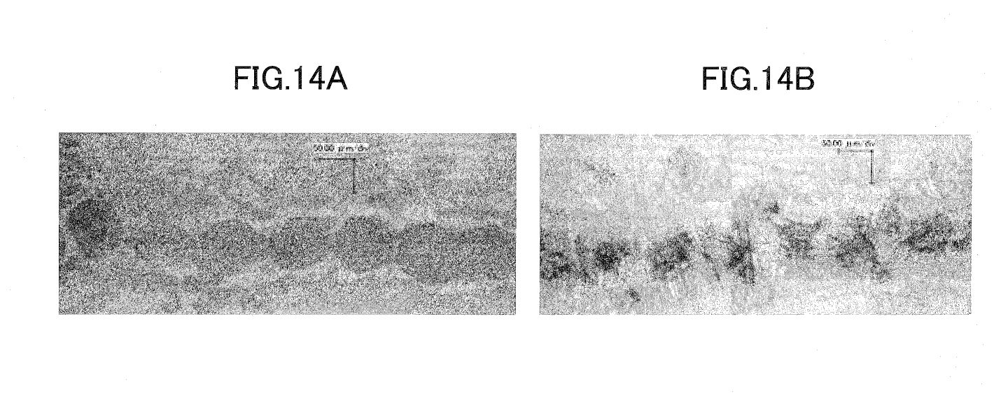

FIG. 14A and FIG. 14B illustrate optical microscopic photographs of an image. Here, FIG. 14A and FIG. 14B are provided for the PET film and the paper sheet for PPC, respectively.

It is found from FIG. 14A that a dot with a blurry or unclear edge was formed on the PET film and bleeding was caused. It is found from FIG. 14B that a dot with an unclear shape was formed on the paper sheet for PPC and significant bleeding was caused.

### PRACTICAL EXAMPLE 2

After 12 parts of a low-molecular weight polystyrene ST-95 with an SP value of 9.2 (cal/cm³)^{0.5} (produced by SANYOKASEI CO., LTD.) were dissolved in 82 parts of isopropyl myristate with an SP value of 8.6 (cal/cm³)^{0.5} while stirring thereof was conducted by using a stirrer, 4 parts of a pigment dispersing agent DISPERBYK-2155 (produced by BYK Japan K.K.) were dissolved therein. After an obtained solution, 2 parts of carbon black #2350 (produced by Mitsubishi Chemical Corporation), and zirconia beads with a diameter of 1 mm were then put into a container, dispersion thereof was conducted for 12 hours by using a ball mill. Moreover, filtration thereof was conducted by using a filter having a pore size of 0.45 μm and made of PTFE to obtain an ink-jet ink.

1 dot line at 600 dpi was printed by using the image formation apparatus 30. Herein, a pulse injector PIJ-15NSET with a single nozzle head (produced by CLUSTER TECHNOLOGY CO., LTD.) was used as the ink-jet head 13. Furthermore, n-hexadecane with an SP value of 8.0 (cal/cm³)^{0.5} was used as the first solvent. Moreover, a urethane foam member was used as the sponge 12. Furthermore, a roller made of a silicone rubber was used as the intermediate transfer roller 31. Moreover, an A4 paper sheet for PPC Mypaper (produced by RICOH COMPANY, LTD.) was used as the paper sheet P. Furthermore, the sponge 12 and the ink-jet head 13 were arranged in such a manner that a period of time from application of the first solvent to the intermediate transfer roller 31 to attachment of the ink-jet ink I to the first solvent was 0.5 seconds. Moreover, the ink-jet head 13 and the pressurization roller 32 were arranged in such a manner that a period of time from attachment of the ink-jet ink I to the first solvent to transfer of an ink-jet ink with an increased viscosity was 0.5 seconds. Furthermore, after the first solvent was applied in such a manner that its amount applied on an entire surface of the intermediate transfer roller 31 was 0.13 mg/cm², about 8 pL of the ink-jet ink I was attached to the first solvent.

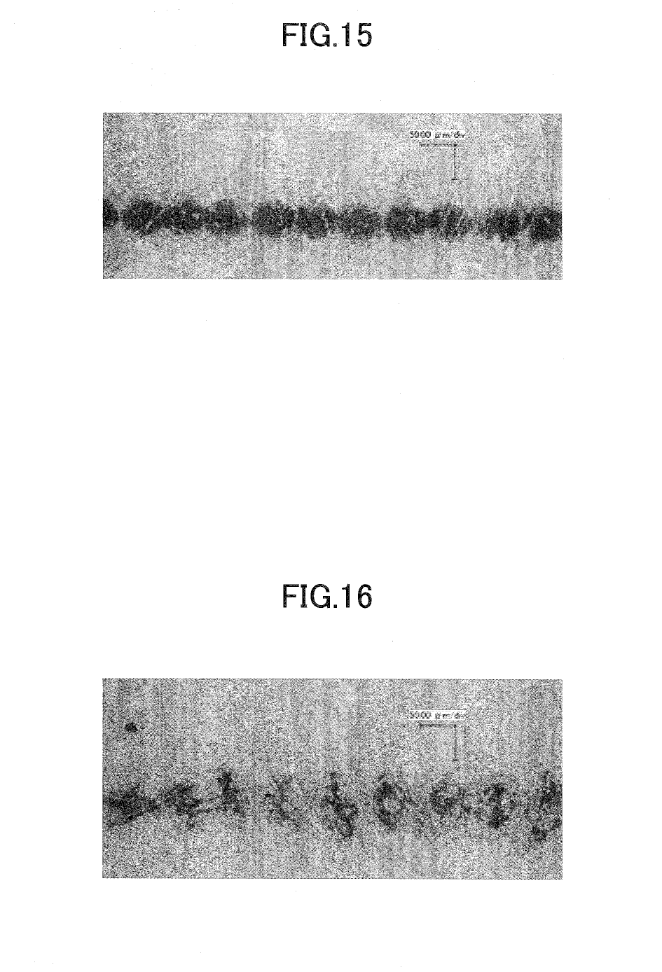

FIG. 15 illustrates an optical microscopic photograph of an image.

It is found from FIG. 15 that a generally circular dot was formed and bleeding was not caused.

Here, it was confirmed that isopropyl myristate was soluble in n-hexadecane and the low-molecular weight polystyrene ST-95 (produced by SANYOKASEI CO., LTD.) was insoluble in n-hexadecane.

Furthermore, after 1 drop of the ink-jet ink was dropped by a dropping pipette onto a slide glass on which n-hexadecane was applied, in an environment at 25° C. and 1 bar, it was observed by an optical microscope that a resin was precipitated on a condition that a pigment was included therein.

### COMPARATIVE EXAMPLE 2

1 dot line at 600 dpi was printed similarly to Practical Example 2 except that the first solvent S was not applied.

FIG. 16 illustrates an optical microscopic photograph of an image.

It is found from FIG. 16 that a dot with an unclear shape was formed and significant bleeding was caused.

### PRACTICAL EXAMPLE 3

After 5 parts of a polyvinyl alcohol POVAL with an SP value of 12.6 (cal/cm³)^{0.5} (produced by KURARAY CO., LTD.) were dissolved in 75 parts of water with an SP value of 23.0 (cal/cm³)^{0.5} while stirring thereof was conducted by using a stirrer, 10 parts of a pigment dispersion fluid for ink jet (produced by DAINICHISEIKA COLOR & CHEMICALS MFG. CO., LTD.) were added thereto. Then, filtration thereof was conducted by using a filter having a pore size of 0.45 μm and made of PTFE to obtain an ink-jet ink.

1 dot line at 600 dpi was printed by using the image formation apparatus 30. Herein, a pulse injector PIJ-15NSET with a single nozzle head (produced by CLUSTER TECHNOLOGY CO., LTD.) was used as the ink-jet head 13. Furthermore, 1,3-butanediol with an SP value of 14.8 (cal/cm³)^{0.5} was used as the first solvent. Moreover, a urethane foam member was used as the sponge 12. Furthermore, a roller made of an NBR rubber was used as the intermediate transfer roller 31. Moreover, an A4 paper sheet for PPC Mypaper (produced by RICOH COMPANY, LTD.) was used as the paper sheet P. Furthermore, the sponge 12 and the ink-jet head 13 were arranged in such a manner that a period of time from application of the first solvent to the intermediate transfer roller 31 to attachment of the ink-jet ink I to the first solvent was 0.5 seconds. Moreover, the ink-jet head 13 and the pressurization roller 32 were arranged in such a manner that a period of time from attachment of the ink-jet ink I to the first solvent to transfer of an ink-jet ink with an increased viscosity was 0.5 seconds. Furthermore, after the first solvent was applied in such a manner that its amount applied on an entire surface of the intermediate transfer roller 31 was 0.080 mg/cm², about 8 pL of the ink-jet ink was attached to the first solvent.

As a result, a generally circular dot was formed and bleeding was not caused, similarly to Practical Example 2.

Here, after 1 drop of the ink-jet ink was dropped by a dropping pipette onto a slide glass on which 1,3-butanediol was applied, in an environment at 25° C. and 1 bar, it was observed by an optical microscope that a resin was precipitated on a condition that a pigment was included therein.

Furthermore, after 1 drop of water was dropped by a dropping pipette onto a slide glass on which 1,3-butanediol was applied, in an environment at 25° C. and 1 bar, it was observed by an optical microscope that water was admixed in 1,3-butandesiol.

### PRACTICAL EXAMPLE 4

While stirring thereof was conducted at 100° C. by using a stirrer, 20 parts of a low-molecular weight polyester with an SP value of 11.5 (cal/cm³)^{0.5} (produced by SANYO CHEMICAL INDUSTRIES, LTD.) were dissolved in 80 parts of diisobutyl adipate with an SP value of 9.1 (cal/cm³)^{0.5}, so that a resin solution was obtained.

After 9 parts of a pigment dispersing agent DISPERBYK-2155 (produced by BYK Japan K.K.), 15 parts of carbon black #2350 (produced by Mitsubishi Chemical Corporation), 76 parts of diisobutyl adipate, and zirconia beads with a diameter of 0.3 mm were put into a container, dispersion thereof was conducted for 5 hours by using a ball mill to obtain a pigment dispersion fluid.

After 50 parts of the resin solution, 33 parts of the pigment dispersion fluid, and 17 parts of diisobutyl adipate were mixed, filtration thereof was conducted by using a filter having a pore size of 0.45 μm and made of PTFE to obtain an ink-jet ink.

1 dot line at 600 dpi was printed similarly to Practical Example 2, except that the obtained ink-jet ink was used, 2,2,4,4,6,8,8-heptamethylnonane with an SP value of 7.3 (cal/cm³)^{0.5} was used as the first solvent, and an A4 coated paper sheet for offset printing RAICHO ART (produced by NIPPON PAPER INDUSTRIES CO., LTD.) was used as the paper sheet P.

As a result, a generally circular dot was formed and bleeding was not caused, similarly to Practical Example 2.

Here, it was confirmed that diisobutyl adipate was soluble in 2,2,4,4,6,8,8-heptamethylnonane and the low-molecular weight polyester was insoluble in 2,2,4,4,6,8,8-heptamethylnonane and soluble in diisobutyl adipate.

Furthermore, after 1 drop of the ink-jet ink was dropped by a dropping pipette onto a slide glass on which 2,2,4,4,6,8,8-heptamethylnonane was applied, in an environment at 25° C. and 1 bar, it was observed by an optical microscope that a resin was precipitated on a condition that a pigment was included therein.

### PRACTICAL EXAMPLE 5

1 dot line at 600 dpi was printed similarly to Practical Example 4, except that hexadecane with an SP value of 8.0 (cal/cm³)^{0.5} was used as the first solvent.

As a result, a generally circular dot was formed and bleeding was not caused, similarly to Practical Example 2.

Here, it was confirmed that diisobutyl adipate was soluble in hexadecane and the low-molecular weight polyester was insoluble in hexadecane.

Furthermore, after 1 drop of the ink-jet ink was dropped by a dropping pipette onto a slide glass on which hexadecane was applied, in an environment at 25° C. and 1 bar, it was observed by an optical microscope that a resin was precipitated on a condition that a pigment was included therein.

### PRACTICAL EXAMPLE 6

1 dot line at 600 dpi was printed similarly to Practical Example 4, except that 2-ethylhexyl isononanoate with an SP value of 8.3 (cal/cm³)^{0.5} was used as the first solvent.

As a result, a generally circular dot was formed and bleeding was not caused, similarly to Practical Example 2.

Here, it was confirmed that diisobutyl adipate was soluble in 2-ethylhexyl isononanoate and the low-molecular weight polyester was insoluble in 2-ethylhexyl isononanoate.

Furthermore, after 1 drop of the ink-jet ink was dropped by a dropping pipette onto a slide glass on which 2-ethylhexyl isononanoate was applied, in an environment at 25° C. and 1 bar, it was observed by an optical microscope that a resin was precipitated on a condition that a pigment was included therein.

### PRACTICAL EXAMPLE 7

While stirring thereof was conducted at 100° C. by using a stirrer, 20 parts of a low-molecular weight polyester with an SP value of 11.5 (cal/cm³)^{0.5} (produced by SANYO CHEMICAL INDUSTRIES, LTD.) were dissolved in 80 parts of triethylene glycol diacetate with an SP value of 9.7 (cal/cm³)^{0.5}, so that a resin solution was obtained.

After 9 parts of a pigment dispersing agent DISPERBYK-2155 (produced by BYK Japan K.K.), 15 parts of carbon black #2350 (produced by Mitsubishi Chemical Corporation), 76 parts of triethylene glycol diacetate, and zirconia beads with a diameter of 0.3 mm were put into a container, dispersion thereof was conducted for 5 hours by using a ball mill to obtain a pigment dispersion fluid.

After 50 parts of the resin solution, 33 parts of the pigment dispersion fluid, and 17 parts of triethylene glycol diacetate were mixed, filtration thereof was conducted by using a filter having a pore size of 0.45 μm and made of PTFE to obtain an ink-jet ink.

1 dot line at 600 dpi was printed similarly to Practical Example 4, except that the obtained ink-jet ink was used and water with an SP value of 23.0 (cal/cm³)^{0.5} was used as the first solvent.

As a result, a generally circular dot was formed and bleeding was not caused, similarly to Practical Example 2.

Here, it was confirmed that triethylene glycol diacetate was soluble in water and the low-molecular weight polyester was insoluble in water and soluble in triethylene glycol diacetate.

Furthermore, after 1 drop of the ink-jet ink was dropped by a dropping pipette onto a slide glass on which water was applied, in an environment at 25° C. and 1 bar, it was observed by an optical microscope that a resin was precipitated on a condition that a pigment was included therein.

### APPENDIX

<An Illustrative Embodiment(s) of an Image Formation Apparatus>

At least one illustrative embodiment of the present invention may relate to an image formation apparatus.

An object of at least one illustrative embodiment of the present invention may be to provide an image formation apparatus capable of suppressing occurrence of bleeding without using a pretreatment fluid that includes an inorganic particle, while a problem(s) involved in a conventional technique is/are taken into consideration.

At least one illustrative embodiment of the present invention may be an image formation apparatus that has application means for applying a first solvent onto a recording medium and jetting means for jetting an ink-jet ink to be attached to the first solvent applied on the recording medium, wherein the ink-jet ink includes a second solvent, a resin, and a coloring material, wherein the second solvent is soluble in the first solvent and the resin is insoluble in the first solvent and soluble in the second solvent.

At least one illustrative embodiment of the present invention may be an image formation apparatus that has an intermediate transfer body, application means for applying a first solvent onto the intermediate transfer body, jetting means for jetting an ink-jet ink to be attached to the first solvent applied on the intermediate transfer body, and transfer means for transferring the ink-jet ink attached to the first solvent to a recording medium, wherein the ink-jet ink includes a second solvent, a resin, and a coloring material, wherein the second solvent is soluble in the first solvent and the resin is insoluble in the first solvent and soluble in the second solvent.

Illustrative Embodiment (1) is an image formation apparatus characterized by having application means for applying a first solvent onto a recording medium and jetting means for jetting an ink-jet ink to be attached to the first solvent applied on the recording medium, wherein the ink-jet ink includes a second solvent, a resin, and a coloring material, wherein the second solvent is soluble in the first solvent and the resin is insoluble in the first solvent and soluble in the second solvent.

Illustrative Embodiment (2) is an image formation apparatus characterized by having an intermediate transfer body, application means for applying a first solvent on the intermediate transfer body, jetting means for jetting an ink-jet ink to be attached to the first solvent applied on the intermediate transfer body, and transfer means for transferring the ink-jet ink attached to the first solvent to a recording medium, wherein the ink-jet ink includes a second solvent, a resin, and a coloring material, wherein the second solvent is soluble in the first solvent and the resin is insoluble in the first solvent and soluble in the second solvent.

Illustrative Embodiment (3) is the image formation apparatus as described in Illustrative Embodiment (1) or (2), characterized in that the first solvent is capable of precipitating the resin as the ink-jet ink is dropped thereon.

Illustrative Embodiment (4) is the image formation apparatus as described in any one of Illustrative Embodiments (1) to (3), characterized in that an area in which the first solvent is applied is generally identical to an area to which the ink-jet ink is attached.

According to at least one illustrative embodiment of the present invention, it may be possible to provide an image formation method and an image formation apparatus that are capable of suppressing occurrence of bleeding without using a pretreatment fluid that includes an inorganic particle.

Although the illustrative embodiment(s) and specific example(s) of the present invention have been described with reference to the accompanying drawing(s), the present invention is not limited to any of the illustrative embodiment(s) and specific example(s), and the illustrative embodiment(s) and specific example(s) may be altered, modified, or combined without departing from the scope of the present invention.

The present application is based on and claims the benefit of priority to Japanese Patent Application No. 2013-104358 filed on May 16, 2013 and Japanese Patent Application No. 2014-010983 filed on Jan. 24, 2014, the entire contents of which are herein incorporated by reference.

1. An image formation apparatus, comprising:
an application part configured to apply a first solvent onto a recording medium; and
a jetting part configured to jet an ink-jet ink to be attached to the first solvent applied on the recording medium,
wherein the ink-jet ink includes a second solvent, a resin, and a coloring material, wherein the second solvent is soluble in the first solvent and the resin is insoluble in the first solvent and soluble in the second solvent.

2. An image formation apparatus, comprising:
an intermediate transfer body;
an application part configured to apply a first solvent on the intermediate transfer body;
a jetting part configured to jet an ink-jet ink to be attached to the first solvent applied on the intermediate transfer body; and
a transfer part configured to transfer the ink-jet ink attached to the first solvent to a recording medium,
wherein the ink-jet ink includes a second solvent, a resin, and a coloring material, wherein the second solvent is soluble in the first solvent and the resin is insoluble in the first solvent and soluble in the second solvent.

3. The image formation apparatus as claimed in claim 1, wherein the first solvent is capable of precipitating the resin as the ink-jet ink is dropped thereon.

4. The image formation apparatus as claimed in claim 2, wherein the first solvent is capable of precipitating the resin as the ink-jet ink is dropped thereon.

5. The image formation apparatus as claimed in claim 1, wherein an area in which the first solvent is applied is substantially identical to an area to which the ink jet ink is attached.

6. The image formation apparatus as claimed in claim 2, wherein an area in which the first solvent is applied is substantially identical to an area to which the ink-jet ink is attached.
